(19) United States
(12) Patent Application Publication
(10) Pub. No.: US 2012/0082480 A1
(43) Pub. Date: Apr. 5, 2012

(54) IMAGE FORMING APPARATUS, MOTOR UNIT AND IMAGE BEARING MEMBER UNIT

(75) Inventor: Atsushi Kimura, Funabashi-shi (JP)

(73) Assignee: CANON KABUSHIKI KAISHA, Tokyo (JP)

(21) Appl. No.: 13/218,702

(22) Filed: Aug. 26, 2011

(30) Foreign Application Priority Data
Oct. 4, 2010 (JP) 2010-224929

(51) Int. Cl. G03G 15/00; H02P 31/00

(52) U.S. Cl. 399/167; 318/490

(57) ABSTRACT

An image forming apparatus includes at least one image bearing member unit including an image bearing member and a motor including an output shaft coupled with the image bearing member to rotary-drive the image bearing member. The output shaft of the motor includes rotation speed detecting means to detect a rotation speed of the output shaft, the rotation speed detecting means being disposed in a vicinity of a node of a torsion resonance mode of the output shaft of the motor.

### BACKGROUND OF THE INVENTION

1. Field of the Invention

The present invention relates to a motor unit rotated by a motor at a predetermined rotation speed, and an image forming apparatus and an image bearing member unit including an image bearing member.

2. Description of the Related Art

Image forming apparatuses such as a color copier and a color printer include image bearing members (photosensitive drums) for four colors (yellow, magenta, cyan and black), and these image bearing members are rotated by motors. Motors to rotary-drive the image bearing members are required not to produce irregular rotation that may adversely affect images to be formed.

To this end, conventional motors are configured to include an output shaft that is an integral shaft directly and integral-rotatably coupled with each image bearing member and an encoder provided at the output shaft to detect a rotation speed so as to control the rotation speed of the image bearing member on the basis of an output signal from the encoder (see U.S. Pat. No. 7,060,969).

The encoder is rotation speed detecting means that detects a rotation angle, the number of rotations, a position and the like and accordingly detects a rotation speed. More specifically, an encoder may be of an optical type including a member to be detected such as a code wheel that is coaxially attached to an output shaft, the code wheel having an optical pattern of a large number of slits arranged at regular intervals in the circumferential direction, and a rotation sensor made up of a light emitting element and a light receiving element sandwiching the code wheel therebetween, for example.

Referring to FIG. 8, such a conventional photosensitive drum used in a color copier is exemplified below. FIG. 9A is a cross-sectional view of a major part of each photosensitive drum unit in FIG. 8.

As illustrated in FIG. 8, the color copier includes four photosensitive drums 70, 71, 72 and 73 corresponding to yellow, magenta, cyan and black, respectively.

As these photosensitive drums 70, 71, 72 and 73 rotate around their shaft centers, toner images formed thereon corresponding to the respective colors are transferred on a transfer member.

Each of the photosensitive drums 70, 71, 72 and 73 is connected with a vibration wave motor 10 as rotary driving means.

More specifically, as illustrated in FIG. 9A, an output shaft 26 extending from each vibration wave motor 10 as an integrated shaft is directly and integral-rotatably coupled with the corresponding photosensitive drum 70, 71, 72 or 73.

Although not described in detail, each photosensitive drum 70, 71, 72 or 73 is coupled with the output shaft 26 in the shaft direction via coupling members and 51 and is coupled therewith in the rotation direction via the coupling member 50.

Therefore, moment of inertia of each photosensitive drum 70, 71, 72 or 73 gives a load to the output shaft 26 at a position of the coupling member 50.

Each vibration wave motor 10 includes a motor housing 12 fixed to a chassis 74 of the color copier.

Referring next to FIG. 9B that is an enlarged cross-sectional view of the motor and its surrounding part in FIG. 9A, the configuration of a driving motor unit is described below.

The vibration wave motor 10 is configured so that a stator ST is fastened to the motor housing 12 with a screw or the like and the stator ST is made up of a piezoelectric element 21 bonded to one face of an elastic member 22 such as stainless steel. Then, a rotor 23 made of an elastic member such as stainless steel is pressed against the stator ST by a pressure spring 25 via a rubber cushion 24.

The pressure spring 25 is firmly fixed to a disk 28, and is press-fitted to the output shaft 26 rotatably supported by two radial bearings BA and BB mounted in the motor housing 12, whereby the rotor 23 is brought into contact with the stator ST under pressure.

A reactive force of the pressure is received by a collar 24 and an inner ring of the radial bearing BB. Then, the disk 28 is integrally coupled with the output shaft 26, thus transmitting the rotation of the rotor to the output shaft 26.

Herein, contacting parts of the stator ST and the rotor 23 undergo quenching or nitriding for improved wear resistance.

Coaxially attached with the output shaft 26 is a code wheel 35 arranged in the motor case 13 so as to be sandwiched between a light emitting element and a light receiving element making up a rotation sensor 36.

Two of the rotation sensors 36 are provided at opposed positions so as to cancel a rotation error component for one cycle per one rotation that is generated when the code wheel 35 is eccentric to the output shaft 26, and the number of rotations is calculated using an average value of signals from the two sensors.

Such a conventional way of controlling the rotation speed of a motor to drive an image bearing member, however, has the following problems.

FIG. 10A and FIG. 10B illustrate a transfer characteristic of the photosensitive drum unit illustrated in FIG. 9A.

FIG. 10A and FIG. 10B are Bode plots of an output from the rotation sensors when a voltage at a frequency different from a driving frequency as disturbance is superimposed on an input voltage of the vibration wave motor. FIG. 10A illustrates a gain (a ratio of input/output) and FIG. 10B illustrates a frequency characteristic of a phase difference.

As is evident from FIG. 10A and FIG. 10B, a notch characteristic is observed at around 500 Hz (indicated with the arrows in the drawings). This results from the following reason.

That is, resonance of torsional vibration of the output shaft 26 occurs at the frequency, where the vibration wave motor 10 and the photosensitive drum 70 (71, 72 or 73) serve as masses (weights) (the arrows in FIG. 9A).

As a result, the notch characteristic is observed because the rotation sensors 36 detect the rotation angle of the vibration wave motor 10 itself as well as the torsion angle displacement due to the vibration.

FIG. 10C schematically illustrates the distribution of angle displacement for the torsion resonance mode of the output shaft 26.

The horizontal axis represents a position of the output shaft 26, and the vertical axis represents the torsion angle. The output shaft 26 torsion-vibrates so as to reciprocate between two solid lines 60.

Since the rotation sensors 36 are arranged at positions with large torsion angle displacement of the torsion resonance mode near the left end of FIG. 10C, the rotation sensors 36 detect the number of rotations of the vibration wave motor 10 including a large torsion vibration component during torsion resonance.

The notch characteristic illustrated in FIG. 10A and FIG. 10B results from the existence of the resonance frequency of such a torsion vibration mode at around 500 Hz, and becomes a factor of narrowing a control range.

Especially in the case of FIG. 10A and FIG. 10B, the gain decreases at around 500 Hz. Therefore, it can be considered that the angle displacement due to torsion resonance has phase opposite to the response of the output from the vibration wave motor. As a result, an attempt to decrease the component of torsion vibration of the irregular rotation will conversely end up in an increase in the component. Although that is the description exemplifying a photosensitive drum unit, any motor unit (configuration without a photosensitive drum) having an output shaft (rotation shaft) of a certain length has a similar problem for torsion vibration mode, which may have a different resonance frequency.

In order to widen the control range, the output shaft 26 may be made thicker or the moment of inertia of the photosensitive drum 70 (71, 72 or 73) may be reduced to increase the resonance frequency of the torsion vibration. However, the current situation makes such modification difficult because of a restriction on the device side.

Herein, the photosensitive drum 70 (71, 72 or 73) is coupled with the output shaft 26 by the coupling member in the shaft direction and in the rotation direction, and is coupled therewith by the coupling member 51 only in the shaft direction. Therefore, the rotation angle of the photosensitive drum 70 (71, 72 or 73) becomes the rotation angle of the output shaft 26 at the position of the coupling member 50.

That is to say, the photosensitive drum 70 (71, 72 or 73) has a uniform angle displacement as in the broken lines 61 of FIG. 10C.

In order to cope with these problems, it is an object of the present invention to provide an image forming apparatus, a motor unit and an image bearing member unit capable of detecting a rotation speed while suppressing influences by a torsion vibration mode of an output shaft of a motor to drive an image bearing member, and capable of controlling the rotation speed of the motor precisely and in a wide frequency band so as to form a high-quality image.

### SUMMARY OF THE INVENTION

An image forming apparatus of the present invention includes at least one image bearing member unit including an image bearing member and a motor including an output shaft coupled with the image bearing member to rotary-drive the image bearing member. The output shaft of the motor includes rotation speed detecting means to detect a rotation speed of the output shaft, the rotation speed detecting means being disposed in a vicinity of a node of a torsion resonance mode of the output shaft of the motor.

A motor unit of the present invention includes an output shaft and a motor coupling with the output shaft to rotary-drive the output shaft. The output shaft of the motor includes rotation speed detection means to detect a rotation speed of the output shaft, the rotation speed detection means being disposed in a vicinity of a node of a torsion resonance mode of the output shaft of the motor.

An image bearing member unit of the present invention includes an image bearing member and a motor including an output shaft coupled with the image bearing member to rotary-drive the image bearing member. The output shaft of the motor includes rotation speed detecting means to detect a rotation speed of the output shaft, the rotation speed detecting means being disposed in a vicinity of a node of a torsion resonance mode of the output shaft of the motor.

According to the present invention, a rotation speed can be detected while suppressing influences by a torsion vibration mode of an output shaft of a motor, and the rotation speed of the motor can be controlled precisely and in a wide frequency band. Such a present invention is used in an image bearing member unit to drive an image bearing member of an image forming apparatus, whereby the image forming apparatus can form high-quality images.

Further features of the present invention will become apparent from the following description of exemplary embodiments with reference to the attached drawings.

### BRIEF DESCRIPTION OF THE DRAWINGS

FIG. 1 is a cross-sectional view of a major part of a photosensitive drum unit in Embodiment 1 of the present invention.

FIG. 2 schematically illustrates torsion angle displacement distribution of a torsion resonance mode of the motor output shaft illustrated in FIG. 1.

FIG. 3A is Bode plots representing a transfer characteristic of the photosensitive drum unit illustrated in FIG. 1.

FIG. 3B is Bode plots representing a transfer characteristic of the photosensitive drum unit illustrated in FIG. 1.

FIG. 4 is a cross-sectional view of a major part of a photosensitive drum unit in Embodiment 2 of the present invention.

FIG. 5 schematically illustrates torsion angle displacement distribution of a torsion resonance mode of the motor output shaft illustrated in FIG. 4.

FIG. 6 is a cross-sectional view of a major part of a photosensitive drum unit in Embodiment 3 of the present invention.

FIG. 7 schematically illustrates torsion angle displacement distribution of a torsion resonance mode of the motor output shaft illustrated in FIG. 6.

FIG. 8 is a schematic perspective view illustrating an example of a conventional photosensitive drum unit used in a color copier.

FIG. 9A is a cross-sectional view of a major part of each photosensitive drum unit in FIG. 8.

FIG. 9B is an enlarged cross-sectional view of the motor and its surrounding part of the photosensitive drum unit illustrated in FIG. 9A.

FIG. 10A is Bode plots representing a transfer characteristic of the photosensitive drum unit illustrated in FIG. 9A.

FIG. 10B is Bode plots representing a transfer characteristic of the photosensitive drum unit illustrated in FIG. 9A.

FIG. 10C schematically illustrates torsion angle displacement distribution of a torsion resonance mode of the motor output shaft illustrated in FIG. 9A.

### DESCRIPTION OF THE EMBODIMENTS

Preferred embodiments of the present invention will now be described in detail in accordance with the accompanying drawings.

### Embodiment 1

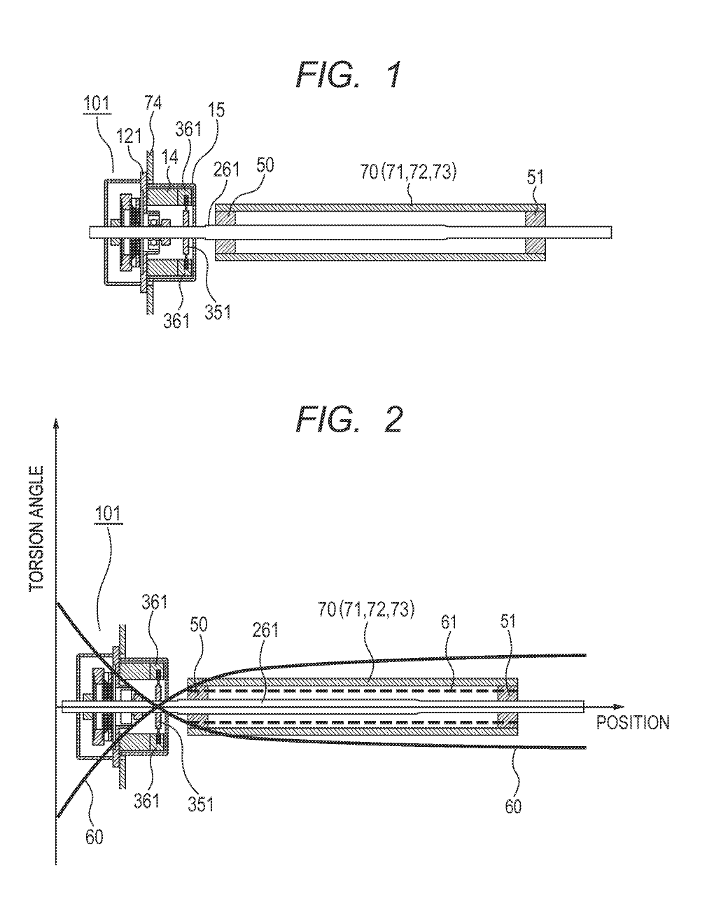

Referring now to FIG. 1, the following describes Embodiment 1 of the present invention that is an image forming apparatus having at least one (i.e., one or a plurality of) image bearing member unit including an image bearing member and a motor including an output shaft integrally coupled with the image bearing member for rotary-driving of the image bearing member. The motor unit in the present invention refers to a unit including the combination of rotary driving means, an output shaft (rotation shaft) and rotation speed detecting means. The image bearing member unit of the present invention is one of preferable embodiments using the present invention, which refers to a unit including the combination of the motor unit and the image bearing member (typically a photosensitive drum) of the present invention.

Although the following describes the configuration of the present invention by referring to an image bearing member unit as one typical example of the present invention, the image bearing member is not essential for the present invention. A rotation target other than the image bearing member may be rotary-driven. Then, the present invention includes a motor unit as well, the motor unit including an output shaft and a motor coupled with the output shaft for rotary-driving of the output shaft, the output shaft of the motor being provided with the rotation speed detecting means to detect the rotation speed of the output shaft, the rotation speed detecting means being arranged in the vicinity of a node of a torsion resonance mode of the output shaft of the motor.

As illustrated in FIG. 1, the image bearing member unit (photosensitive drum unit) of the present embodiment includes a photosensitive drum 70 (71, 72 or 73) connected with a vibration wave motor 101 as rotary driving means. Then, an output shaft 261 extending from the vibration wave motor 101 as an integral shaft is directly and integral-rotatably coupled with the photosensitive drum 70 (71, 72 or 73).

The photosensitive drum 70 (71, 72 or 73) is coupled with the optical shaft 261 in the shaft direction via the coupling members 50 and 51 and is coupled therewith in the rotation direction via the coupling member 50. The vibration wave motor 101 includes a motor housing 121 fixed to a chassis 74 of a color copier.

The output shaft 261 is provided with rotation speed detecting means to detect a rotation speed of the output shaft 261.

This rotation speed detecting means is an encoder including a code wheel 351 as a member to be detected and a rotation sensor 361, and is means to detect a rotation angle, the number of rotations, a position and the like and accordingly detect a rotation speed.

More specifically, the code wheel 351 is coaxially attached between the vibration wave motor 101 and the photosensitive drum 70 (71, 72 or 73).

Then, two opposed rotation sensors 361 made up of a light emitting element and a light receiving element are fixed to the motor housing 121 via a base 14 so as to sandwich the code wheel 351 therebetween, thus configuring the rotation speed detecting means.

The vibration wave motor 101 is controlled on the basis of a signal output from the rotation sensors 361 so that the rotation speed is constant.

Note here that since toner floating inside the color copier, especially in the vicinity of the photosensitive drums may degrade the optical performance of the rotation speed detecting means, the rotation speed detecting means may be covered by a cover member to prevent the intrusion of foreign objects from the outside.

For instance, an encoder cover 15 may be attached to the motor housing 121 so as to cover both of the code wheel 351 and the rotation sensor 361.

FIG. 2 schematically illustrates the angle displacement distribution of a torsion resonance mode of the output shaft 261 of the photosensitive drum unit illustrated in FIG. 1.

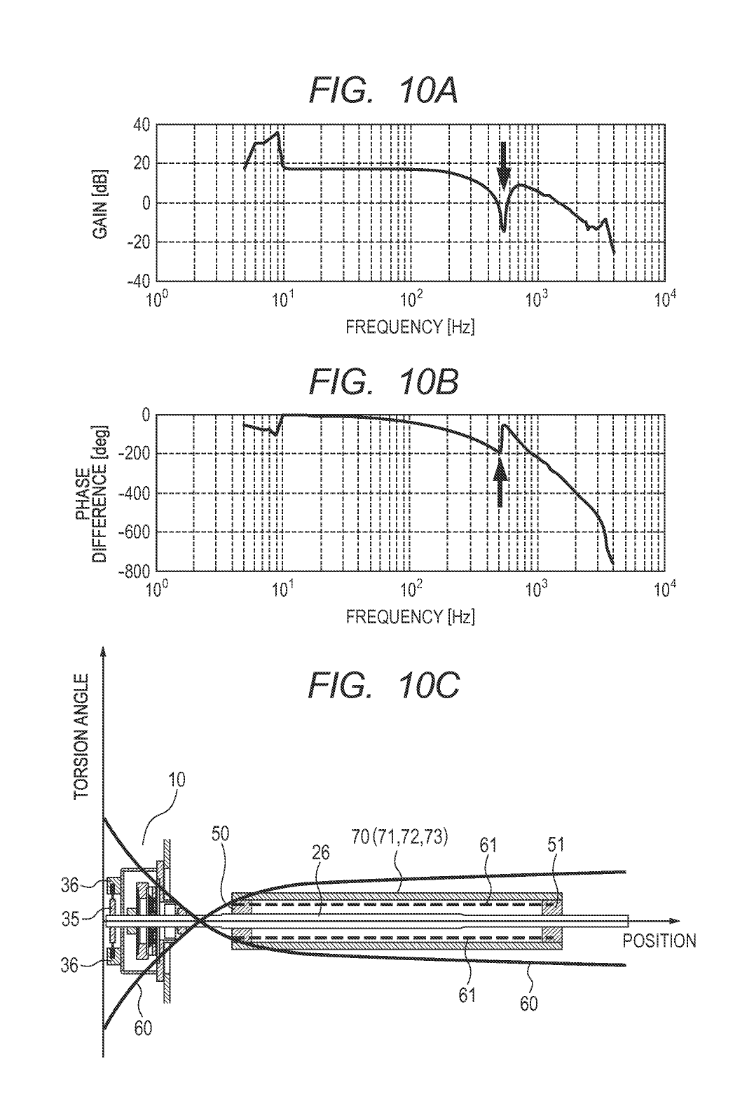

Similarly to the conventional example in FIG. 10C, the output shaft 261 torsion-vibrates so as to reciprocate between two solid lines 60.

In the present embodiment, however, the code wheel 351 is arranged in the vicinity of a position where an angle displacement of a torsion resonance mode is 0, i.e., in the vicinity of a node of the torsion resonance mode. Therefore, a signal output from the rotation sensors 361 does not include a component of the torsion resonance. In the present invention, the vicinity of a node of the torsion resonance mode includes not only a strict position of a node of the torsion resonance mode but also a position that can be substantially regarded as a node of the torsion resonance mode within the range of assembly accuracy.

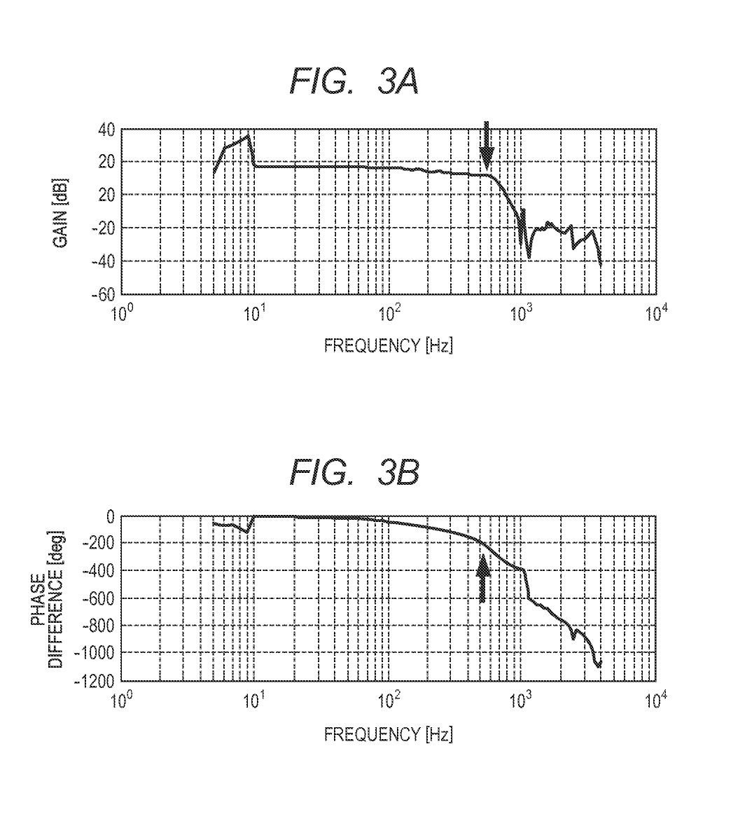

FIGS. 3A and 3B are Bode plots representing a transfer characteristic of such a system. FIG. 3A illustrates a gain (a ratio of input/output) and FIG. 3B illustrates a frequency characteristic of a phase difference.

As compared with FIG. 10A and FIG. 10B illustrating the conventional example, a notch characteristic at around 500 Hz hardly appears (the arrows in the drawings).

Therefore, since such a system is free from the restriction by torsion resonance on a control gain, a wide control range can be obtained therefrom.

That is, a control margin can be increased because an irregular rotation component resulting from torsion resonance is not detected, and so a control gain can be increased and the accuracy can be improved.

Note here that the present invention does not remove an irregular rotation component resulting from torsion resonance by controlling.

### Embodiment 2

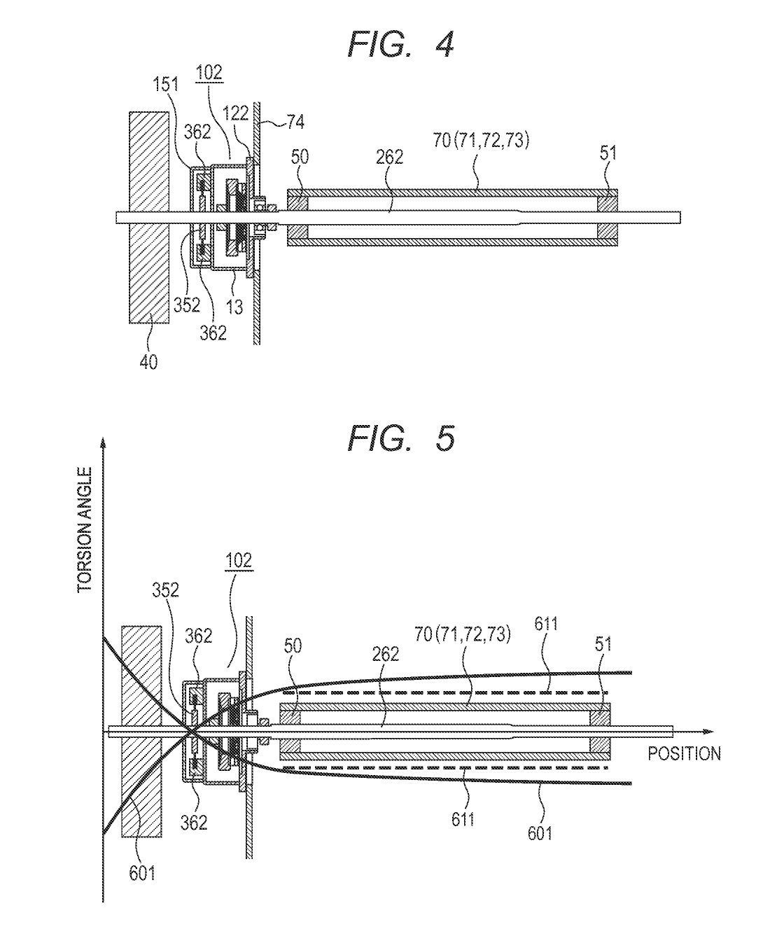

Referring now to FIG. 4, the following describes Embodiment 2 that is an image bearing member unit (photosensitive drum unit) having an adjustment mass. The description on a part common to Embodiment 1 has been omitted.

As illustrated in FIG. 4, a photosensitive drum unit of the present embodiment includes a photosensitive drum 70 (71, 72 or 73) connected with a vibration wave motor 102 as rotary driving means.

Then, an output shaft 262 extending from the vibration wave motor 102 as an integral shaft is directly and integral-rotatably coupled with the photosensitive drum (71, 72 or 73).

The photosensitive drum 70 (71, 72 or 73) is coupled with the optical shaft 262 in the shaft direction via coupling members 50 and 51 and is coupled therewith in the rotation direction via the coupling member 50.

The vibration wave motor 102 includes a motor housing 122 fixed to a chassis 74 of a color copier.

Similarly to the conventional example, coaxially attached with the output shaft 262 is a code wheel 352, and two opposed rotation sensors 362 are fixed to a motor case 13. The vibration wave motor 102 is controlled on the basis of a signal output from the rotation sensors 362 so that the rotation speed is constant. The output shaft is further provided with an adjustment mass (weight) 40 on the opposite side of the coupling side with the image bearing member so as to sandwich the motor therebetween, and is configured so that a position of a node of a torsion resonance mode of the output shaft of the motor is set between the motor 102 and the adjustment mass 40. More specifically, the adjustment mass 40 is attached on the opposite side of the photosensitive drum 70 (71, 72 or 73) with reference to the vibration wave motor 102, and a position of a node of a torsion resonance mode of the output shaft of the motor is set between the motor and the adjustment mass.

The code wheel 352 and the rotation sensors 362 are then arranged between the vibration wave motor 102 and the adjustment mass 40 and in the vicinity of a node of a torsion resonance mode.

In the present embodiment, an encoder cover 151 is attached to the motor case 13 so as to cover the code wheel 352 and the rotation sensors 362. Such an encoder cover 151 is not essential because the code wheel 352 and the rotation sensors 362 are away from the photosensitive drum (71, 72 or 73) and are less influenced by toner.

FIG. 5 schematically illustrates the angle displacement distribution of a torsion resonance mode of the output shaft 262 of the photosensitive drum unit illustrated in FIG. 4.

The output shaft 262 torsion-vibrates so as to reciprocate between two solid lines 601 (broken lines 611 represent a rotation angle of the photosensitive drum 70 (71, 72 or 73)).

Note here that the adjustment mass 40 of the present embodiment allows a position of a node of a torsion resonance mode to move toward the adjustment mass 40 and to be positioned just near the code wheel 352. Therefore, a signal output from the rotation sensors 362 does not include a component of the torsion resonance, and a control gain can be increased even in the resonance frequency band.

### Embodiment 3

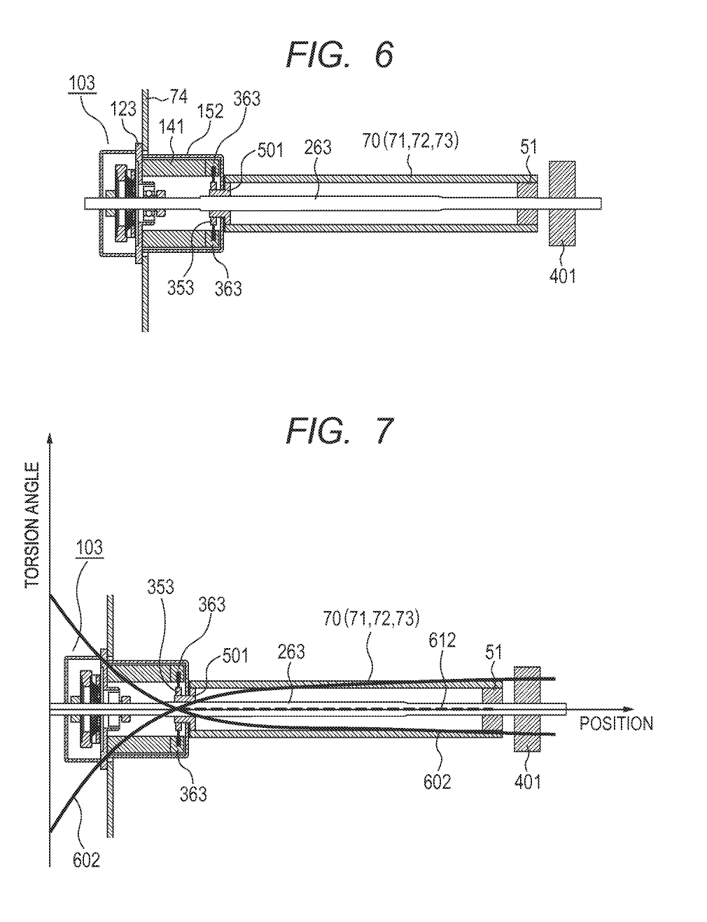

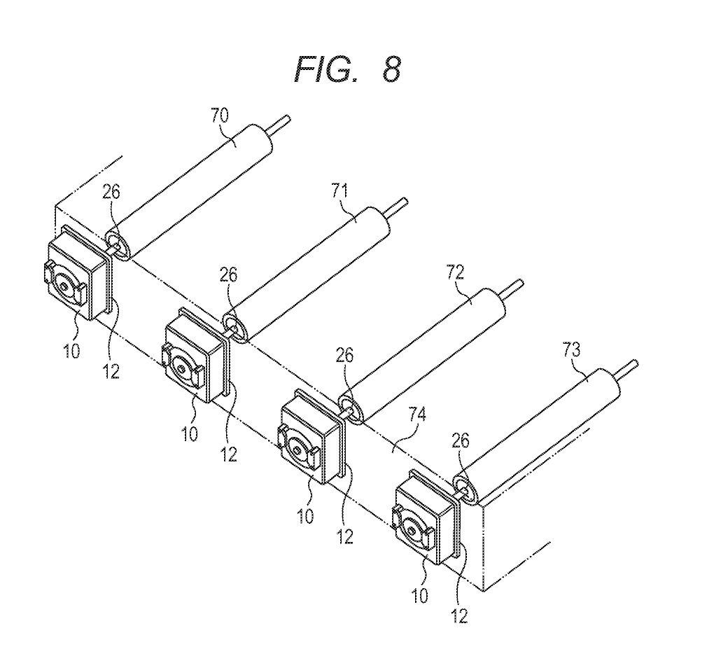

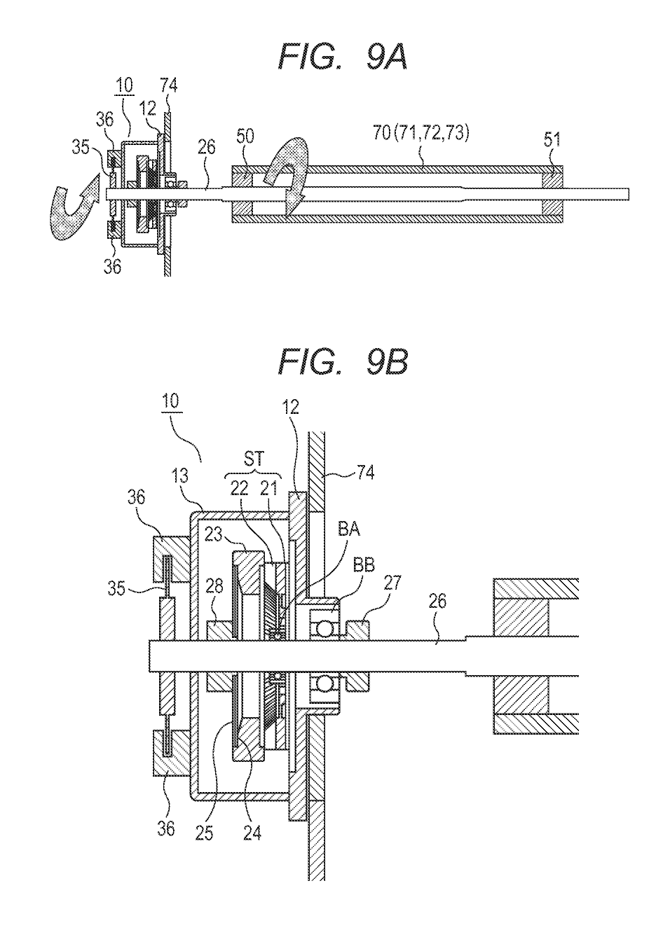

Referring now to FIG. 6, the following describes Embodiment 3 that is an image bearing member unit (photosensitive drum unit) having an adjustment mass arranged at a different position from that in Embodiment 2. The description on a part common to Embodiments 1 and 2 has been omitted.

As illustrated in FIG. 6, a photosensitive drum unit of the present embodiment includes a photosensitive drum 70 (71, 72 or 73) connected with a vibration wave motor 103 as rotary driving means.

Then, an output shaft 263 extending from the vibration wave motor 103 as an integral shaft is directly and integral-rotatably coupled with the photosensitive drum (71, 72 or 73).

The photosensitive drum 70 (71, 72 or 73) is coupled with the optical shaft 263 in the shaft direction via coupling members 501 and 51 and is coupled therewith in the rotation direction via the coupling member 501. The vibration wave motor 103 includes a motor housing 123 fixed to a chassis 74 of a color copier.

In the present embodiment, coaxially attached with the output shaft 263 is a code wheel 353 via the coupling member 501, and two opposed rotation sensors 363 are fixed to the motor housing 123 via a base 141.

The vibration wave motor 103 is controlled on the basis of a signal output from the rotation sensors 363 so that the rotation speed is constant.

The output shaft is further provided with an adjustment mass (weight) on the opposite side of the motor 103 so as to sandwich the position where the image bearing member is coupled with the output shaft in the rotation direction (i.e., the position of the coupling member 501) therebetween. Then, the output shaft is configured so that a position of a node of a torsion resonance mode of the output shaft of the motor is set in the vicinity of the coupling position of the image bearing member with the output shaft (i.e., in the vicinity of the position of the coupling member 501).

More specifically, the output shaft 263 is provided with an adjustment mass 401 on the opposite side of the vibration wave motor 103 with reference to the photosensitive drum 70 (71, 72 or 73), and a position of a node of a torsion resonance mode of the output shaft of the motor is set in the vicinity of the coupling position of the image bearing member with the output shaft. In the present embodiment, since the code wheel 353 and the rotation sensors 363 are close to the photosensitive drum (71, 72 or 73), an encoder cover 152 is attached to the motor housing 123 so as to cover these elements.

FIG. 7 schematically illustrates the angle displacement distribution of a torsion resonance mode of the output shaft 263 of the photosensitive drum unit illustrated in FIG. 6.

The output shaft 263 torsion-vibrates so as to reciprocate between two solid lines 602. Note here that the adjustment mass 401 of the present embodiment allows a position of a node of a torsion resonance mode to move toward the adjustment mass 401 and to be positioned just around the code wheel 353.

Therefore, a signal output from the rotation sensors 363 does not include a component of the torsion resonance, and a control gain can be increased in the resonance frequency band.

In the present embodiment, not only the code wheel 353 but also the coupling member 501 substantially coincide with a position of a node of a torsion resonance mode, and therefore the photosensitive drum 70 (71, 72 or 73) hardly generates irregular rotation resulting from torsion resonance (broken lines 612 of FIG. 7).

As described above, according to the configurations of these embodiments, the number of rotations of a motor can be detected without influences of a torsion resonance mode of the motor output shaft, thus enabling control in a frequency band higher than a resonance frequency of the torsion vibration mode.

The above descriptions of the embodiments deal with the case of using a vibration wave motor as a driving motor because the vibration wave motor has features of excellent responsibility and a wide control range, and so the effects of the present invention can be especially remarkably obtained with the vibration wave motor.

The present invention, however, is not limited to such a configuration, and can be used in a photosensitive drum unit using an electromagnetic motor as well.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-224929, filed Oct. 4, 2010, which is hereby incorporated by reference herein in its entirety.

What is claimed is:

1. An image forming apparatus comprising at least one image bearing member unit including an image bearing member and a motor including an output shaft coupled with the image bearing member to rotary-drive the image bearing member, wherein
the output shaft of the motor includes rotation speed detecting means to detect a rotation speed of the output shaft, the rotation speed detecting means being disposed in a vicinity of a node of a torsion resonance mode of the output shaft of the motor.

2. The image forming apparatus according to claim 1, wherein
the rotation speed detecting means includes an encoder made up of a member to be detected and a rotation sensor including a light emitting element and a light receiving element disposed so as to sandwich the member to be detected therebetween, and
the member to be detected is integrally coupled with the output shaft of the motor and is disposed in a vicinity of a node of a torsion resonance mode of the output shaft of the motor.

3. The image forming apparatus according to claim 1, further comprising an adjustment mass on an opposite side of an image bearing member-coupling side of the output shaft so as to sandwich the motor therebetween,
wherein a position of a node of a torsion resonance mode of the output shaft of the motor is set between the motor and the adjustment mass.

4. The image forming apparatus according to claim 1, further comprising an adjustment mass on an opposite side of a motor side of the output shaft so as to sandwich a position of the image bearing member coupling with the output shaft in a rotation direction therebetween,
wherein a position of a node of a torsion resonance mode of the output shaft of the motor is set in a vicinity of the position of the image bearing member coupling with the output shaft in the rotation direction.

5. The image forming apparatus according to claim 1, further comprising an adjustment mass on an opposite side of a motor side of the output shaft so as to sandwich a position of the image bearing member coupling with the output shaft in a rotation direction therebetween,
wherein a position of a node of a torsion resonance mode of the output shaft of the motor is set in a vicinity of the position of the image bearing member coupling with the output shaft,
the rotation speed detecting means includes an encoder made up of a member to be detected and a rotation sensor including a light emitting element and a light receiving element disposed so as to sandwich the member to be detected therebetween, and
the image bearing member and the output shaft are coupled with a coupling member, and the member to be detected is disposed via the coupling member.

6. The image forming apparatus according to claim 1, further comprising a cover member covering the rotation speed detecting means to prevent intrusion of foreign objects from outside.

7. The image forming apparatus according to claim 1, wherein the motor is a vibration wave motor.

8. An image bearing member unit comprising an image bearing member and a motor including an output shaft coupled with the image bearing member to rotary-drive the image bearing member, wherein
the output shaft of the motor includes rotation speed detecting means to detect a rotation speed of the output shaft, the rotation speed detecting means being disposed in a vicinity of a node of a torsion resonance mode of the output shaft of the motor.

9. The image bearing member unit according to claim 8, wherein
the rotation speed detecting means includes an encoder made up of a member to be detected and a rotation sensor including a light emitting element and a light receiving element disposed so as to sandwich the member to be detected therebetween, and
the member to be detected is integrally coupled with the output shaft of the motor and is disposed in a vicinity of a node of a torsion resonance mode of the output shaft of the motor.

10. The image bearing member unit according to claim 8, further comprising an adjustment mass on an opposite side of an image bearing member-coupling side of the output shaft so as to sandwich the motor therebetween,
wherein a position of a node of a torsion resonance mode of the output shaft of the motor is set between the motor and the adjustment mass.

11. The image bearing member unit according to claim 8, further comprising an adjustment mass on an opposite side of a motor side of the output shaft so as to sandwich a position of the image bearing member coupling with the output shaft in a rotation direction therebetween,
wherein a position of a node of a torsion resonance mode of the output shaft of the motor is set in a vicinity of the position of the image bearing member coupling with the output shaft in the rotation direction.

12. The image bearing member unit according to claim 8, further comprising an adjustment mass on an opposite side of a motor side of the output shaft so as to sandwich a position of the image bearing member coupling with the output shaft in a rotation direction therebetween,
wherein a position of a node of a torsion resonance mode of the output shaft of the motor is set in a vicinity of the position of the image bearing member coupling with the output shaft,
the rotation speed detection means includes an encoder made up of a member to be detected and a rotation sensor including a light emitting element and a light receiving element disposed so as to sandwich the member to be detected therebetween, and
the image bearing member and the output shaft are coupled with a coupling member, and the member to be detected is disposed via the coupling member.

13. The image bearing member unit according to claim 8, further comprising a cover member covering the rotation speed detection means to prevent intrusion of foreign objects from outside.

14. The image bearing member unit according to claim 8, wherein the motor is a vibration wave motor.

15. A motor unit comprising an output shaft and a motor coupling with the output shaft to rotary-drive the output shaft,
wherein
the output shaft of the motor includes rotation speed detection means to detect a rotation speed of the output shaft, the rotation speed detection means being disposed in a vicinity of a node of a torsion resonance mode of the output shaft of the motor.
